(19) United States
(12) Patent Application Publication
(10) Pub. No.: US 2003/0043327 A1
(43) Pub. Date: Mar. 6, 2003

(54) Liquid crystal display apparatus using IPS display mode with high numerical aperture

(76) Inventors: Tetsuya Aoyama, Kawagoe (JP); Kenji Okishiro, Kokubunji (JP); Etsuko Nishimura, Hitachiota (JP); Shinichi Komura, Hitachi (JP); Katsumi Kondou, Mito (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/098,075

(22) Filed: Mar. 15, 2002

(30) Foreign Application Priority Data
Aug. 29, 2001 (JP) 2001-259571

(51) Int. Cl. G02F 1/1343

(52) U.S. Cl. 349/141

(57) ABSTRACT

A liquid crystal display apparatus including: a first substrate; a second substrate arrange opposite the first substrate; a liquid crystal layer held between the first substrate and the second substrate; a plurality of scanning lines arranged over the first substrate; a plurality of zigzag-shaped signal lines having bent portions, arranged crossing the scanning lines over the substrate; insulating films arranged over at least part of the signal lines; pixel electrodes matching the signal lines; and common electrodes matching the pixel electrodes and superposed over at least part of the signal lines via the insulating films, in which the bent portions of the zigzag-shaped signal lines are curved.

### CROSS-REFERENCE TO RELATED APPLICATIONS

The present invention is related to U.S. patent application Ser. No. ______ (Hitachi docket No. 110100589US01) filed, 2002 entitled “LIQUID CRYSTAL DISPLAY APPARATUS USING IPS DISPLAY MODE WITH HIGH RESPONSE” claiming the Convention Priority based on Japanese Patent Application No. 2001-261744.

### BACKGROUND OF THE INVENTION

The present invention relates to a liquid crystal display apparatus having a novel electrode configuration.

Liquid crystal display apparatuses according to the prior art use a display mode in which an electric field substantially normal to the substrate surface is applied, typically the twisted nematic (TN) display mode. However, the TN display mode involves the problem of an insufficient viewing angle characteristic.

On the other hand, the in-plane switching (IPS) display mode is proposed in JP-B-63-21907, U.S. Pat. No. 4,345,249, WO 91/10936, JP-A-6-160878 specifications and others. In the IPS display mode, a comb electrode for driving a liquid crystal is formed on one of paired substrates holding the liquid crystal between them, and an electric field having a component substantially parallel to the liquid crystal is applied to the substrate surface. Since liquid crystal molecules are driven in a plane substantially parallel to the substrate surface then, a wider viewing angle than in the TN display mode can be obtained.

However, broadly classified, this IPS display mode involves the following two problems.

(1) The color tone varies with the visual angle.

(2) The opaque comb electrode reduces the aperture ratio.

In order to solve the problem stated in (1) above, according to JP-A-9-258269 specification for instance, there is proposed a multi-domain IPS display mode having a structure in which electrodes and wiring groups on the substrate are bent in zigzag shapes. The electrode structure in this multi-domain IPS display mode is shown in FIG. 3 and FIG. 4. FIG. 4 shows an A-A section of FIG. 3. FIG. 2 illustrates an equivalent circuit of the drive system in this liquid crystal display apparatus.

In this structure, it is possible to pluralize the domain in which the rotating direction of liquid crystal molecules differs within a single pixel when an electric field is applied and to use their compensating effect to restrain the dependence of color tone on the visual angle.

The domains of wide common electrodes 36 arranged on both sides of each signal line 31 cannot transmit light, thereby inviting a decrease in aperture ratio. In view of this factor, in order to solve the problem stated in (2) above, a structure in which the common electrodes 36 and the signal lines 31 are superposed is proposed in, for instance, WO 98-47044 (U.S. Pat. No. 6,208,399) and other references. These electrode structures are illustrated in FIG. 7 and FIG. 8. FIG. 8 shows an A-A section of FIG. 7. The equivalent circuit diagram of the drive system in this liquid crystal display apparatus is the same as FIG. 2.

In the structure referred to above, as the wide common electrodes 36, which are arranged beside signal lines in IPS according to the prior art and cannot transmit light, can now be effectively utilized as light transmissive domains, it is possible to increase the aperture ratio. Furthermore, the liquid crystal molecules on the superposed common electrodes 36 are not driven and, even if transparent electrodes are used as the superposed common electrodes 36, no light is transmitted by those domains (self-shielding), there will be no need for the light-shielding black matrix in the signal line extending direction 37 of the opposite substrate (color filter substrate).

This means that the aperture ratio arising from misalignment between the TFT substrate and the color filter substrate can be suppressed, and accordingly the aperture ratio can be improved over the conventional IPS. Incidentally, such a superposed structure is known as a super self shield (SSS) structure because of its self-shielding effect mentioned above.

### SUMMARY OF THE INVENTION

However, a liquid crystal display apparatus that can be compatible with the extreme fineness expected in the future will require further improvement in aperture ratio.

As stated above, in a liquid crystal display apparatus of an SSS structure, since the common electrodes superposed over signal lines are designed to be wider than other pixel electrodes and common electrodes in the pixels, and the liquid crystal molecules on these common electrodes are not driven and do not transmit light, the width of these common electrodes greatly contributes to reducing the aperture ratio. Therefore, if these common electrodes superposed over signal lines can be narrowed, a substantial increase in aperture ratio can be expected.

However, the width of these common electrodes is determined according to whether or not the noise field from the signal lines to the pixel electrodes can be sufficiently shielded against. As shown in FIG. 19, a noise field 62 from a signal line 31 enters into an electric field generated between a common electrode 36 and a pixel electrode 35, and disturbs an intrinsic electric field 61 between a pixel electrode and a common electrode for driving the liquid crystal.

A case of driving a liquid crystal display apparatus successively from the scanning line closest to the scanning driver onward (line sequential driving) is considered below, for instance.

The scanning voltage is applied so as to turn on the TFTs successively from that on the first line onward, and a voltage to be supplied to each pixel electrode is supplied to the signal line timed with the turning-on of the TFT on each line. It is supposed here that a voltage for displaying black is supplied to the signal line at the timing when the TFT on the n-th line is turned on and a voltage for displaying white is supplied to the signal line at the timing when the TFT on the [n+m]-th (m>0) line is turned on. Then, an electric field for displaying black should theoretically be applied between the pixel electrode and the common electrode on the n-th line, but, at the timing when the TFT on the [n+m]-th line is turned on, a voltage for displaying white is applied to the signal line, the field from this signal line functions as a noise field on the pixel on the n-th line, so that a light leak occurs in the vicinity of the superposed common electrode in spite of the display of black by the pixel on the n-th line.

Such a light leak arises in the extending direction of the signal line (longitudinal direction on the display screen), resulting in a display failure known as “longitudinal smear”. It is a phenomenon of a slight increase in the luminance of black at an evaluation point 53, when for instance the pattern shown in FIG. 18 is displayed on the screen, compared with that in the complete absence of display. In order to restrain this longitudinal smear, a sufficient width CL should be secured for the superposed common electrode 36, and the noise field 62 from the signal line 31 should be shielded against (FIG. 19).

As apparent from the foregoing, the narrower the superposed common electrode, the greater the aperture ratio, but the noise field from the signal line cannot be sufficiently shielded against on the other hand, resulting in the occurrence of a longitudinal smear. Conversely, the wider the superposed common electrode, the easier the prevention of the longitudinal smear, but this invites a further reduction in aperture ratio. Especially in an SSS structure, the width of the common electrode superposed over the signal line is a parameter that can significantly contribute to preventing faulty displaying due to a longitudinal smear and increasing the aperture ratio.

An object of the present invention, therefore, is to provide a liquid crystal display apparatus in which noise fields from signal lines, which would invite longitudinal smears, and the width of common electrodes superposed over signal lines are reduced and the aperture ratio is thereby increased.

Another object of the present invention is to provide a liquid crystal display apparatus increased in effective aperture ratio in the bent portions of common electrodes and pixel electrodes.

A summary of the present invention to attain the objects stated above is as follows.

[1] A liquid crystal display apparatus comprising a first substrate; a second substrate arranged opposite the first substrate; a liquid crystal layer held between the first substrate and the second substrate;

a plurality of scanning lines arranged over the first substrate; a plurality of zigzag-shaped signal lines having bent portions, arranged crossing the scanning lines over the substrate; insulating films arranged over at least part of the signal lines; pixel electrodes matching the signal lines; and common electrodes matching the pixel electrodes and superposed over at least part of the signal lines via the insulating films; wherein:

the bent portions of the zigzag-shaped signal lines are curved.

[2] The liquid crystal display apparatus as set forth above wherein the bent portions of the zigzag-shaped signal lines are bent stepwise at a plurality of angles.

[3] The liquid crystal display apparatus as set forth above wherein the bent portions of the zigzag-shaped signal lines have parts parallel to the extending direction of the signal lines.

[4] Any liquid crystal display apparatus of those set forth in [1] through [3] above, wherein at least one layer of the insulating films is selectively formed in a smaller width than the common electrodes in the part where the signal lines and the common electrodes are superposed.

[5] A liquid crystal display apparatus comprising a first substrate; a second substrate arranged opposite the first substrate; a liquid crystal layer held between the first substrate and the second substrate;

a plurality of scanning lines arranged over the first substrate; signal lines arranged crossing the scanning lines over the substrate; dogleg-shaped pixel electrodes matching the signal lines and having bent portions; and dogleg-shaped common electrodes matching the pixel electrodes and having bent portions; wherein:

at least part of the bent portion of the pixel electrodes and part of the bent portion of the common electrodes are curved.

[6] The liquid crystal display apparatus wherein at least part of the bent portion of the pixel electrodes and part of the bent portion of the common electrodes are bent stepwise at a plurality of angles.

[7] The liquid crystal display apparatus wherein at least part of the bent portion of the pixel electrodes and part of the bent portion of the common electrodes have parts parallel to the extending direction of the pixel electrodes.

[8] Any liquid crystal display apparatus of those set forth in [1] through [4] above, wherein the pixel electrodes and the common electrodes are formed in dogleg shapes having bent portions; and at least part of the bent portions of the pixel electrodes and part of the bent portions of the common electrodes are curved.

[9] At least part of the dogleg-shaped bent portions of the pixel electrodes and the bent portions of the common electrodes may be bent stepwise at a plurality of angles.

[10] Also, at least part of the dogleg-shaped bent portions of the pixel electrodes and the bent portions of the common electrodes may have parts parallel to the extending direction of the pixel electrodes.

According to the present invention, since electric field concentration in the bent portions of the signal lines, pixel electrodes and common electrodes is eased, the width of the common electrodes superposed over the signal lines can be reduced, the aperture ratio can be increased, localization of electric charges in the bent portions can be eased to restrain display failure in the bent portions, and the aperture ratio can be increased in effect.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B illustrate a configuration of a liquid crystal display apparatus according to the present invention in the vicinity of a pixel;

FIG. 2 illustrates a configuration of the liquid crystal display apparatus both according to the prior art and the present invention;

FIG. 3 illustrates a configuration of a pixel and its vicinity in the configuration of the conventional liquid crystal display apparatus;

FIG. 4 illustrates a configuration of a pixel and its vicinity in a section of the conventional liquid crystal display apparatus;

FIGS. 5A and 5B illustrate a shape of a bent portion of a signal line in the conventional liquid crystal display apparatus;

FIG. 6 illustrates a noise field between the signal line and a common electrode in the conventional liquid crystal display apparatus;

FIGS. 7A and 7B illustrate a configuration of a pixel and its vicinity in another conventional liquid crystal display apparatus;

FIG. 8 illustrates a section of a pixel and its vicinity in the conventional liquid crystal display apparatus;

FIG. 9 illustrates a noise field between the signal line and the common electrode in the liquid crystal display apparatus both according to the prior art and the present invention;

FIGS. 10A through 10C illustrate the shape of the bent portion of the signal line in the liquid crystal display apparatus according to the invention;

FIGS. 11A and 11B illustrate the shape of the bent portion of the common electrode and the pixel electrode in the liquid crystal display apparatus both according to the prior art and the invention;

FIGS. 12A and 12B illustrate the shape of the bent portion of the common electrode and the pixel electrode in the liquid crystal display apparatus according to the invention;

FIGS. 13A and 13B illustrate the configuration of a pixel and its vicinity in the configuration of the liquid crystal display apparatus according to the invention;

FIG. 14 illustrates a section of a pixel and its vicinity in the liquid crystal display apparatus according to the invention;

FIGS. 15A and 15B illustrate a configuration of a pixel and its vicinity in the conventional liquid crystal display apparatus;

FIGS. 16A through 16I illustrate the electrode and wiring formation process;

FIGS. 17A through 17D show partially expanded views of a photomask for use in forming bent portions;

FIG. 18 illustrates an example of display pattern and evaluation spot in evaluating longitudinal smears; and

FIG. 19 illustrates a noise field in an SSS structure.

### DETAILED DESCRIPTION OF THE EMBODIMENTS

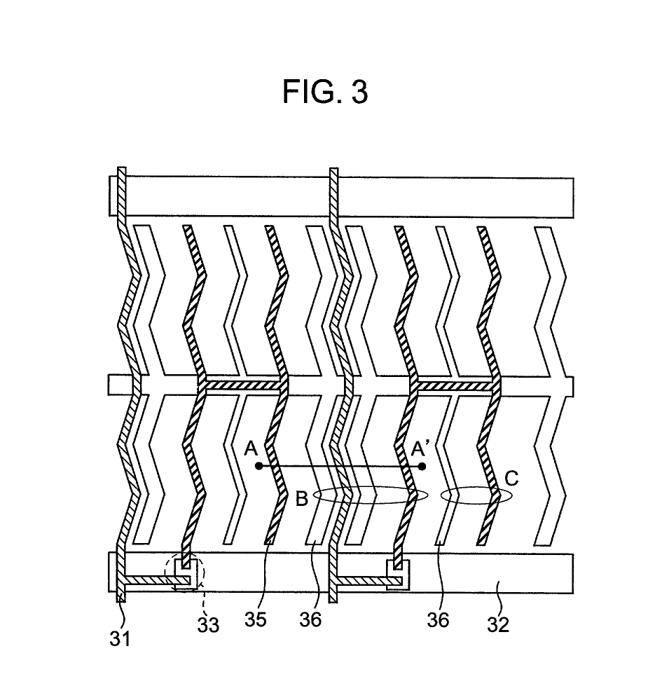

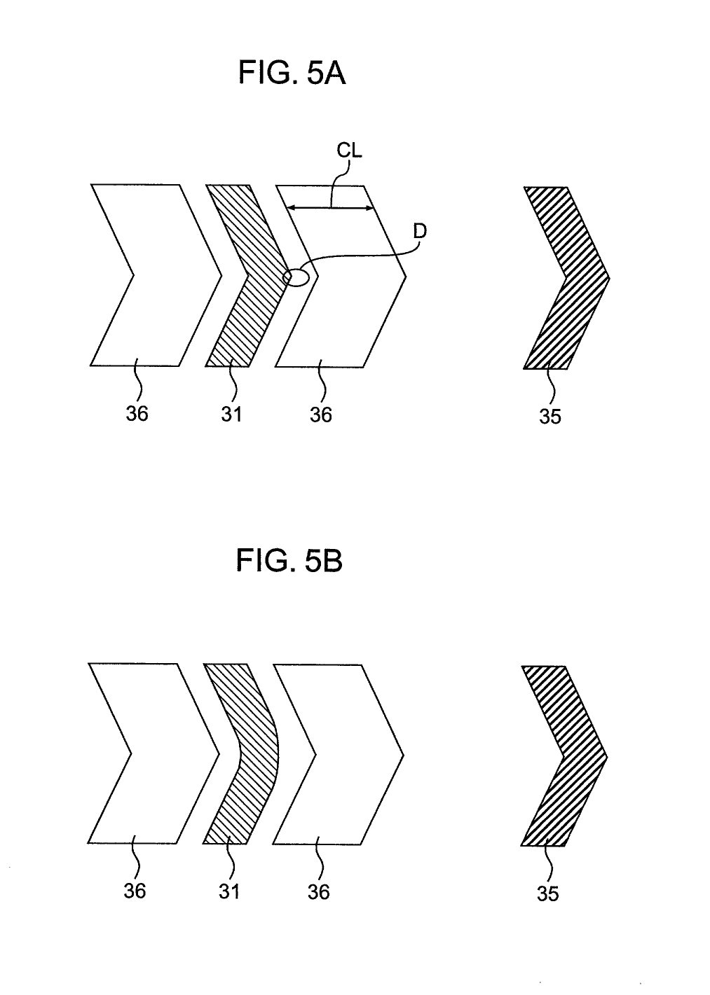

In a liquid crystal display apparatus using a multi-domain IPS display mode according to the prior art, as shown in FIG. 3, it is required to secure a sufficient width for the common electrodes 36 arranged in the vicinities of the signal line 31 so that the electric potential of the signal lines may not disturb the electric fields between the common electrodes 36 and the pixel electrodes 35. Meeting this requirement results in an enlarged width of the common electrodes 36 and thereby invites a decrease in aperture ratio. Therefore it is desirable to narrow the width of the common electrodes 36. A bent portion of a signal line is focused on here and described with reference to FIGS. 5A and 5B illustrating area B in FIG. 3 on an expanded scale.

Whereas an electric field is generated between a signal line 31 and a common electrode 36 as shown in FIG. 5A, this electric field becomes a noise field that disturbs the electric field between the common electrode 36 and a pixel electrode 35 to be used for displaying. Especially in the bent portion, electric field concentration occurs in area D where the signal line is more sharply bent in a dogleg shape, resulting in an expanded noise field.

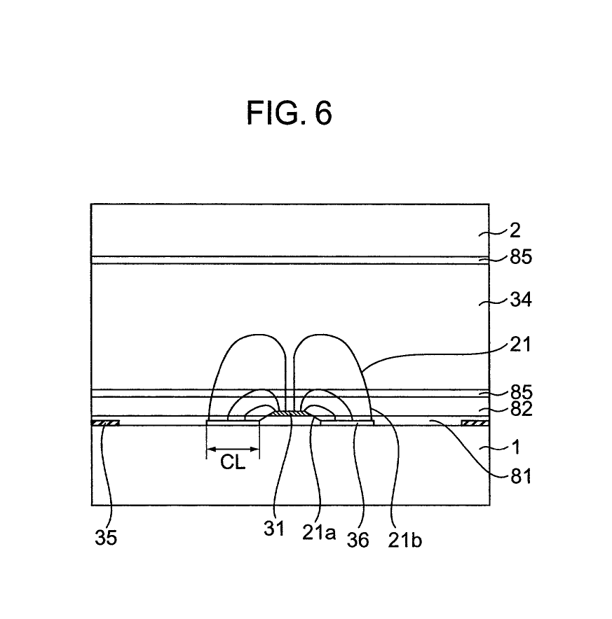

This electric field concentration can be eased by rounding the dogleg-shaped bent portion of the signal line 31 as shown in FIG. 5B. This, however, cannot reduce the width CL of the common electrodes 36. This point will be explained with reference to FIG. 6.

As illustrated in FIG. 6, the electric line of force 21a of the noise field generating from an edge of the signal line 31 reaches the edge of the common electrodes 36 closer to the signal line 31. On the other hand, the electric line of force 21b of the noise field generating from the central part of the signal line 31 reaches the edge of the common electrode 36 farther from the signal line 31.

Thus, in ensuring that the noise field between the signal line 31 and the common electrodes 36 may not disturb the electric field between the common electrode 36 and the pixel electrode 35 used for displaying, the electric line of force 21b becomes a key factor to the determination of the width CL of the common electrodes 36. In this respect, even though the noise field attributable to the electric line of force 21a can be eased by rounding the bent portion of the signal line 31, it hardly contributes to reducing the width CL of the common electrode 36. Therefore, such an electrode structure as the multi-domain IPS display mode shown in FIG. 3 would not serve to increase the aperture ratio.

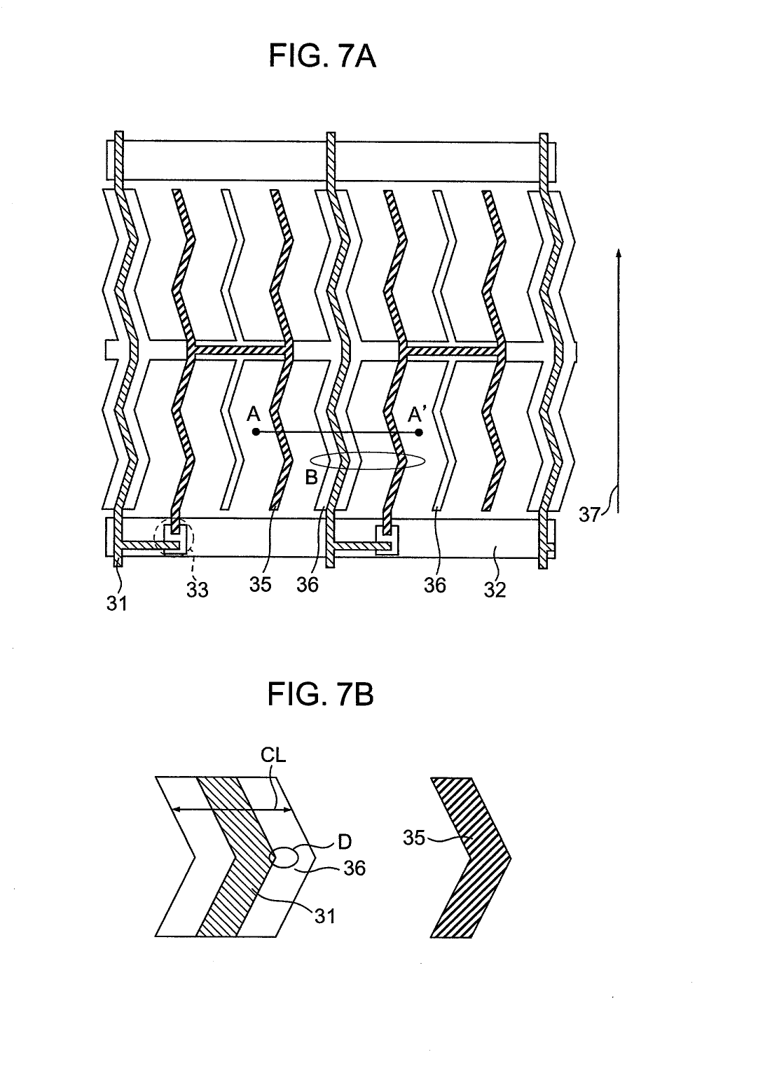

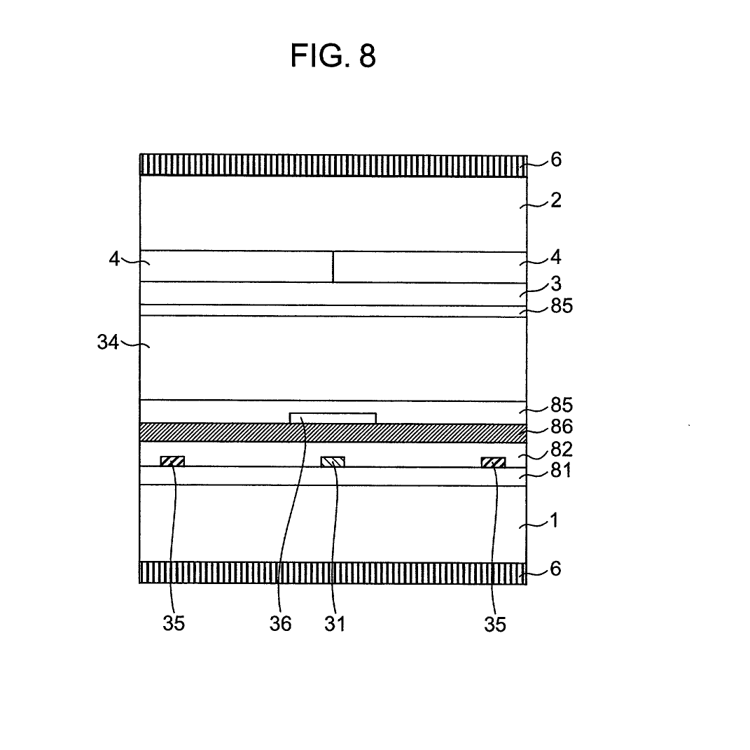

On the other hand, a liquid crystal display apparatus in which an SSS structure with an increased aperture ratio and a multi-domain IPS display mode by putting together two common electrodes 36 into one unit and superposing it over the signal line 31 via an insulating film will be described below with reference to FIGS. 7A, 7B and 8.

FIG. 7A illustrates the configuration in a pixel and its vicinity. It differs from the liquid crystal display apparatus using the multi-domain display mode shown in FIG. 3 in that the signal line 31 and the common electrode 36 are partly superposed via an insulating film having a low dielectric constant (not shown) arranged all over the pixel.

FIG. 8 shows an A-A′ section of FIG. 7A. This configuration has a substrate 1 made of transparent glass, another substrate 2 arranged opposite the substrate 1 and also made of transparent glass, and a liquid crystal layer 34 held between the substrates 1 and 2.

The substrate 1 has an insulating film 81, a signal line 31 and pixel electrodes 35 both arranged over the insulating film 81, a protective film 82 arranged over these electrodes, a low-dielectric constant insulating film 86 arranged over the protective film 82, a common electrode 36 superposed over the signal line 31 via the low-dielectric constant insulating film 86, an alignment film 85 arranged on the boundary with the liquid crystal 34, and a polarizer 6 arranged on the other side than the liquid crystal side of the substrate 1 and varying its optical characteristic according to the alignment of the liquid crystal.

The substrate 2 has a color filter 4 for expression colors respectively corresponding to R (red), G (green) and B (blue), a flattening film 3 arranged over the color filter 4 to flatten the unevenness of the filter, the alignment film 85 over the flattening film 3, and the polarizer 6 over the other side than the liquid crystal side of the substrate 2.

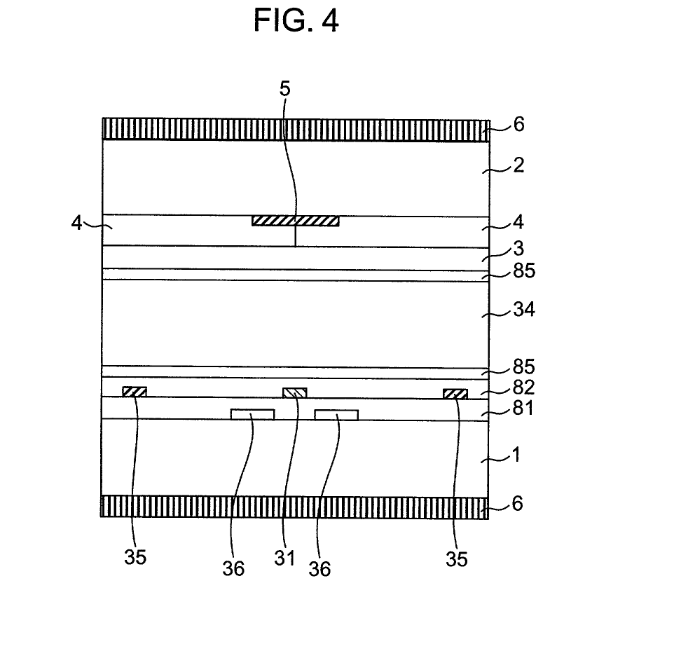

Unlike in the liquid crystal display apparatus using the multi-domain IPS display mode shown in FIG. 4, no black matrix is arranged, because, since the noise field from the signal line 31 is shielded against by the superposed common electrode 36, the liquid crystal over the common electrode 36 superposed over the signal line 31 is not switched to, resulting in the prevention of unnecessary light leaks. However, since light leaks from the vicinity of the scanning line 32 (FIG. 7), a black matrix for shielding against this unnecessary light is arranged over the scanning line 32.

Picture displaying is accomplished by supplying an electric field whose components are parallel to the substrate 1 onto the liquid crystal 34 with the common electrodes 36 and the pixel electrodes 35 and thereby rotating the liquid crystal 34 in a plane substantially parallel to the substrate 1.

In this system, as the signal lines 31 and the common electrodes 36 are superposed, the aperture ratio is greater than in the conventional multi-domain IPS display mode shown in FIG. 3. However, even in this system, it is necessary to secure a sufficient width for the common electrodes 36 to prevent the noise field between the signal lines 31 and the common electrodes 36 from disturbing the electric field between, the common electrodes 36 and the pixel electrodes 35 for use in displaying. As a result, the width of the common electrodes 36 becomes too great, inviting a decrease in aperture ratio. Therefore, it is desirable to reduce the width of these common electrodes 36.

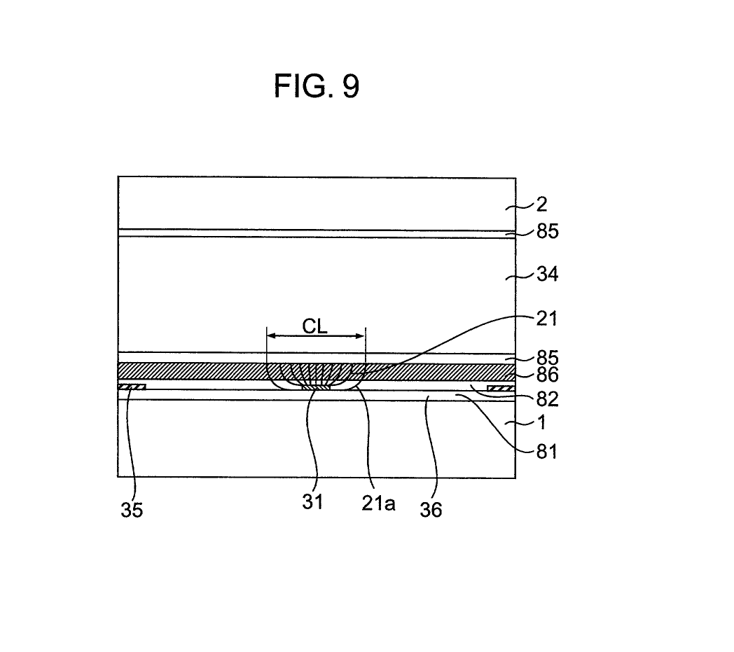

A method to achieve it will be described below with reference to FIG. 7B, which is a partial expansion of FIG. 7A, with focus on the bent portions of the signal lines.

Whereas a noise field arises between the signal lines 31 and the common electrodes 36, electric field concentration occurs particularly in area D of each bent portion where the signal lines are sharper, resulting in an increased noise field. The electric field in this situation will be described with reference to FIG. 9.

Unlike in the case of the multi-domain IPS display mode shown in FIG. 6, the electric line of force 21a of the noise field generating from the ends of the signal line 31 reaches the farther end of the common electrode 36 from the signal line 31. Therefore, if the noise field from the ends of the signal line 31 can be reduced, the width CL of the common electrode 36 can be narrowed.

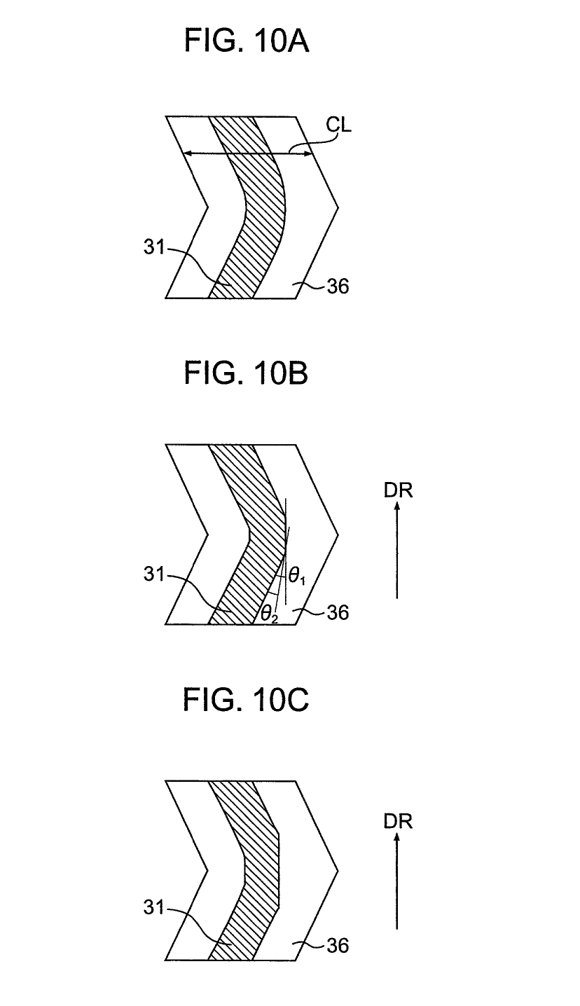

In order to reduce the noise field from the ends of the signal line 31, electric field concentration can be eased by rounding the bent portion of the signal line to make it a curve as shown in FIG. 10A, and this serves to reduce the noise field. Also where the corner is flattened straight as shown in FIG. 10B, bending the portion stepwise at a plurality of angles in the extending direction DR of the signal line 31, the noise field can be reduced. Further, by forming the bent portion to be parallel to the extending direction DR of the signal line 31 as shown in FIG. 10C, the noise field can be reduced, too.

Thus, the noise field can be reduced by minimizing sharper corners of the bent portion, and the width CL of the common electrodes 36 can also be reduced thereby, resulting in an increased aperture ratio.

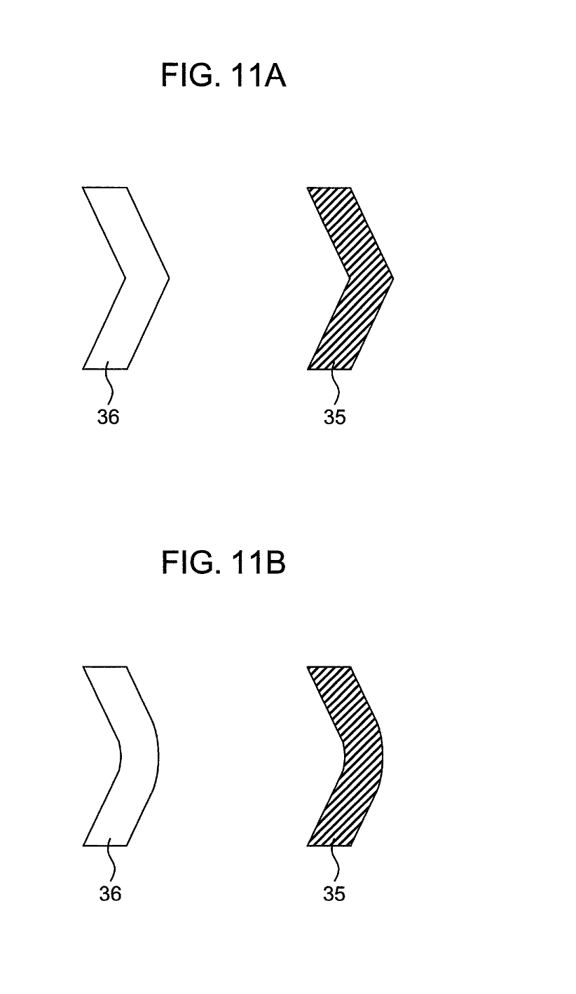

Next, the focus is on area C, where the pixel electrodes 35 and the common electrodes 36 shown in FIG. 3 are bent. Electric field concentration will be explained below with reference to FIG. 11A, which shows an expanded view of this area C.

As the bent portion of the pixel electrode 35 and the common electrode 36 is sharper, electric field concentration occurs here. This electric field concentration causes electrically charged substances, such as ions, in the liquid crystal layer to be localized in the bent portion subjected to electric field concentration. In this case, the electric field for displaying is disturbed and prevented from providing proper displaying, inviting a decrease in aperture ratio in effect.

On the other hand, in FIG. 11B, the bent portion is rounded into a curve, which serves to ease electric field concentration and thereby makes it difficult for faulty display to occur. Thus, by rounding bent portions between the pixel electrodes 35 and the common electrodes 36 to form curves, electric field concentration can be eased to increase the aperture ratio in effect.

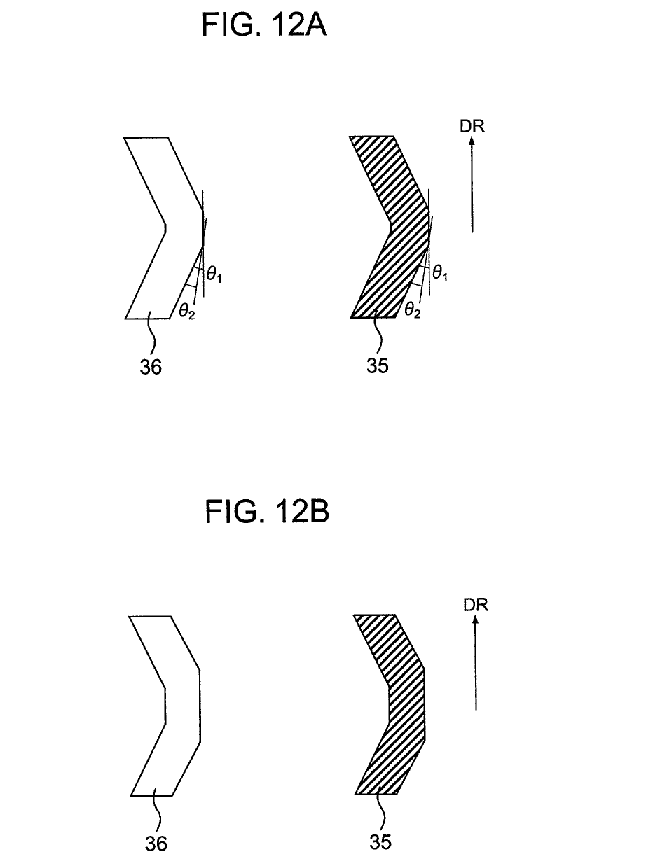

Further, as shown in FIG. 12A, where the corner is flattened straight, by bending the portion stepwise at a plurality of angles in the extending direction DR of the pixel electrodes 35, electric field concentration can be eased to achieve a similar effect. Further, by forming the bent portion to be parallel to the extending direction DR of the pixel electrodes 35 as shown in FIG. 12B, electric field concentration can be eased to achieve a similar effect.

Incidentally, the noise field in this contest is observed as faulty display with longitudinal smears as mentioned above. Therefore, the shielding effect against the noise field from the signal lines can be evaluated and determined by measuring the longitudinal smear intensity explained below.

FIG. 18 illustrates an example of longitudinal smear evaluating pattern. In the central part of the screen is presented a window pattern 52 in white, with the background of a black display 51. The width of the window pattern in the longitudinal direction (the extending direction of signal wiring) here is supposed to be ½ of the width Y of the screen in the longitudinal direction.

At the evaluation point 53 shown in FIG. 18, the difference in luminance between a state in which the window pattern is displayed and one in which it is not evaluated. The longitudinal smear intensity is defined to be (A−B)/B×100(%), where A is the luminance at the evaluation point when the window pattern is displayed and B, the luminance at the same point when the window pattern is not displayed. It is empirically known that if the longitudinal smear intensity is less than 3% under such conditions, the longitudinal smear will be invisible as such.

Next will be described the present invention in more specific terms with reference to embodiments thereof.

[Embodiment 1]

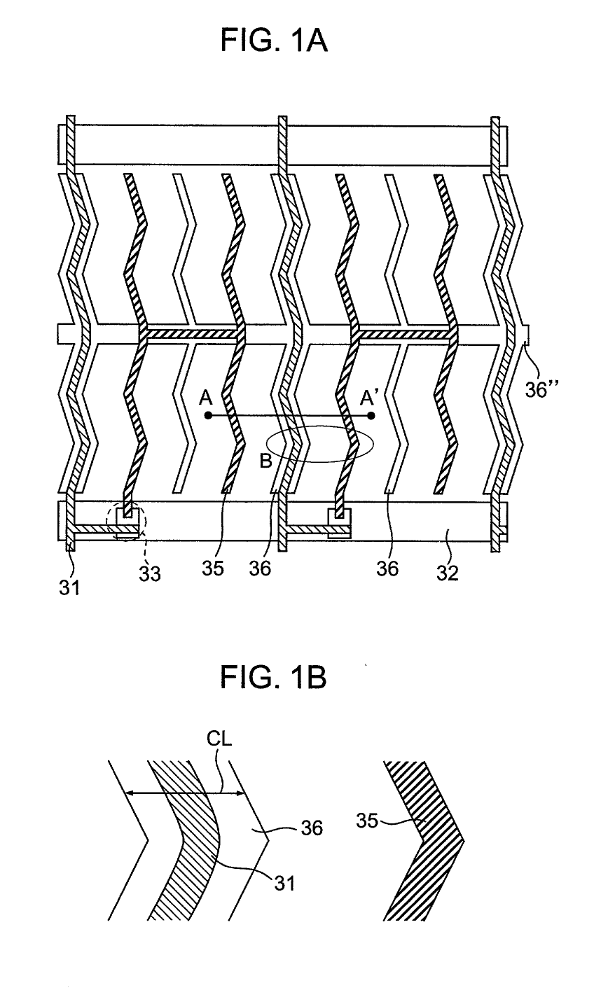

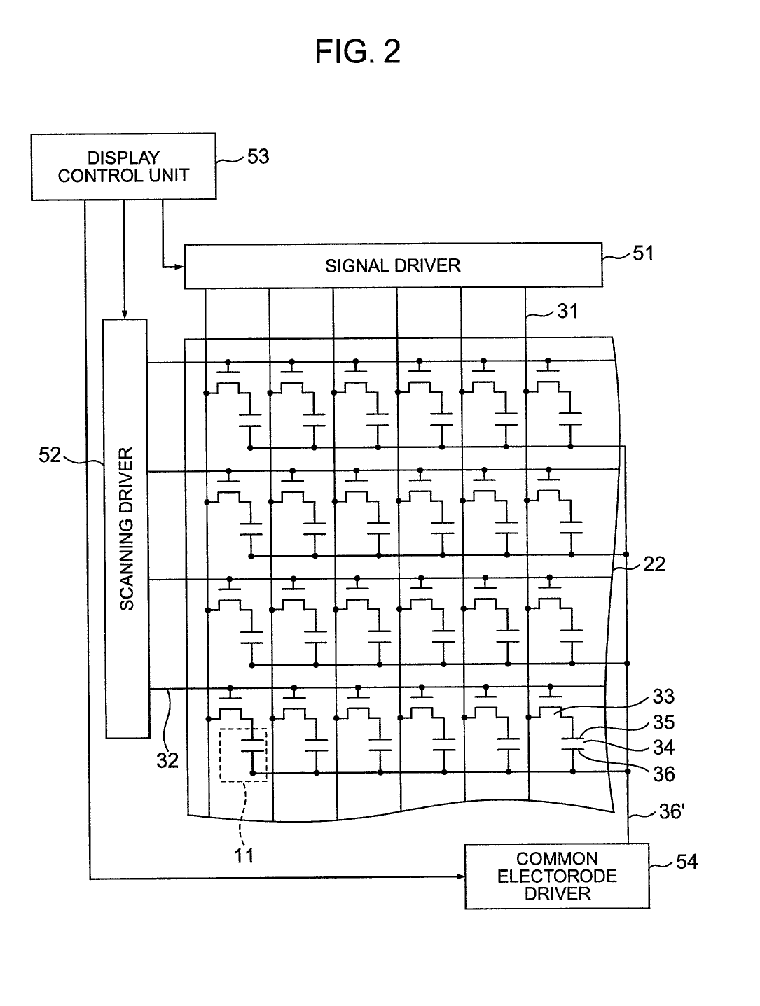

The pixel configuration in a liquid crystal display apparatus constituting this embodiment will be described with reference to FIGS. 1A, 1B and 8. The liquid crystal display apparatus embodying the invention, as shown in FIG. 2, has a signal driver 51 for supplying a signal potential to each pixel electrode 35, a scanning driver 52 for supplying a potential for selecting a pixel, a common electrode driver 54 for supplying a potential to each common electrode 36, and a display control unit 53 for controlling the signal driver 51, the scanning driver 52 and the common electrode driver 54.

The substrate 1 (FIG. 8) is provided with a plurality of scanning lines 32 connected to the scanning driver 52, the signal lines 31 connected to the signal driver 51 and crossing the scanning lines 32, TFTs 33 arranged in a matching way near the intersections between the scanning lines 32 and the signal lines 31 and electrically connected to the scanning lines 32 and the signal lines 31, the pixel electrodes 35 electrically connected to the TFTs 33 and matching the signal lines 31, the common electrodes 36 matching the pixel electrodes 35, and electrode connecting portions 36′ electrically connected to the common electrodes 36 and the common electrode driver 54.

Each of the pixels 11 is formed in an area surrounded by signal lines 31 and scanning lines 32, and this plurality of pixels 11 constitute a display section 22.

FIG. 1A illustrates a configuration of a pixel and its vicinity in this embodiment. The scanning lines 32 and the signal lines 31 cross each other, and a pixel is formed matching an area surrounded by scanning lines 32 and signal lines 31.

Each of the TFTs 33 is arranged in a matching way near the intersection between a scanning line 32 and a signal line 31, and electrically connected to the scanning line 32, the signal line 31 and the pixel electrode 35.

Each of the common electrodes 36 is arranged matching a pixel electrode 35, and the common electrode 36 and the pixel electrode 35 generate an electric field whose components are parallel to the substrate surface. The pixel electrode 35, the common electrode 36 and the signal line 31 are bent once or more within each pixel to constitute a multi-domain. The signal line 31 and the common electrode 36 are partly superposed via a low-dielectric constant insulating film (not shown) arranged all over the pixel.

Now will be described the methods of forming each electrode and wiring line. Usually, electrodes and wiring lines are patterned by photolithography. Insulating films of SiNx or the like intervening between electrodes and wiring lines are formed by plasma chemical vapor deposition (CVD). By repeating a number of times each the process of photolithography to form these electrodes and wiring lines and insulating film formation of SiNx or the like by plasma CVD or otherwise, there is completed a TFT array substrate having electrodes and wiring lines formed in different layers with insulating films between them.

Since the shape of the bent portions of signal lines constitutes a particularly salient point of the present invention, the photolithographic process to form the electrodes and wiring lines will be described in some detail below.

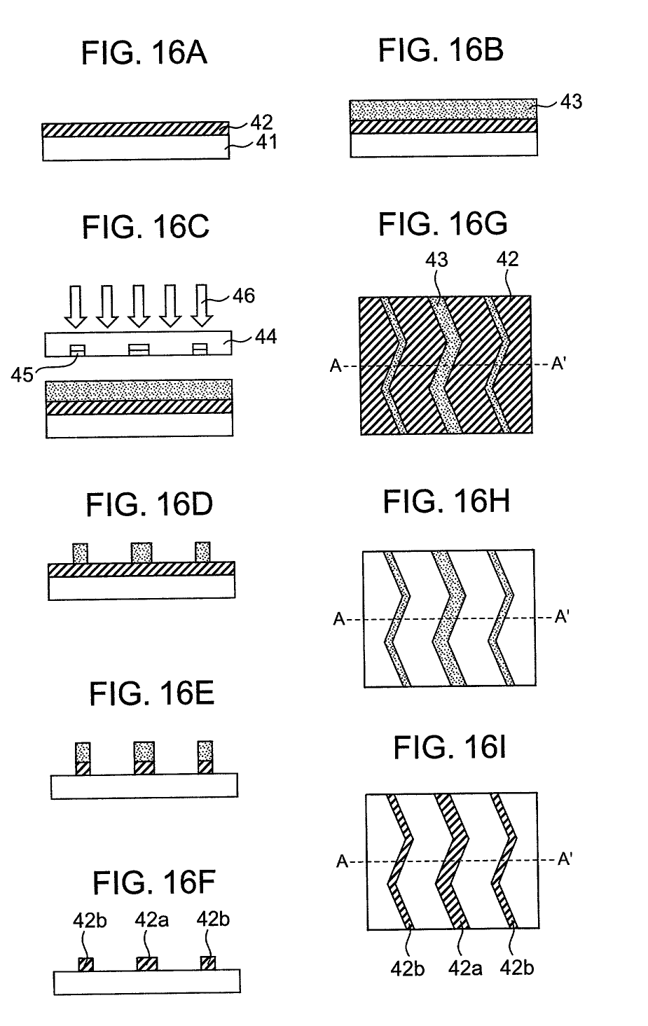

FIGS. 16A through 16I illustrate the flow of electrode wiring line formation by the photolithographic process in plans and sections of the electrode substrate in that connection. In the photolithographic process, broadly divided, consists of six steps including the formation of electrodes and wiring films (formation of patterned films) followed by cleaning, shown in FIG. 16A, resist application and pre-baking in FIG. 16B, exposure to light in FIG. 16C, development and post-baking in FIG. 16D, etching in FIG. 16E and resist peeling in FIG. 16F.

Each of FIGS. 16A through 16F shows a section of the substrate at each step, while each of FIGS. 16G through 16I shows a plan of the substrate, with A-A′ sections in the latter corresponding to FIGS. 16D through 16F, respectively.

First, as shown in FIG. 16A, an electrode and wiring line material film 42 of Cr or the like is formed by sputtering or otherwise all over the surface of a substrate 41 where it is desired to form an electrodes and wiring lines. Incidentally, any material with a low electrical resistance can be used for wiring lines including signal lines and scanning lines without problem, and such properly usable materials include Al, Cu and CrMo alloy.

Next, the formed film is cleaned, and a photoresist 43 is applied with a spin coater or the like as shown in FIG. 16B over the film, followed by pre-baking.

Then, at the exposure step shown in FIG. 16C, the photoresist 43 is exposed to light by irradiation with UV rays 46 through a photomask board 44, followed by development and post-baking, and the photomask pattern is transcribed to a resist pattern.

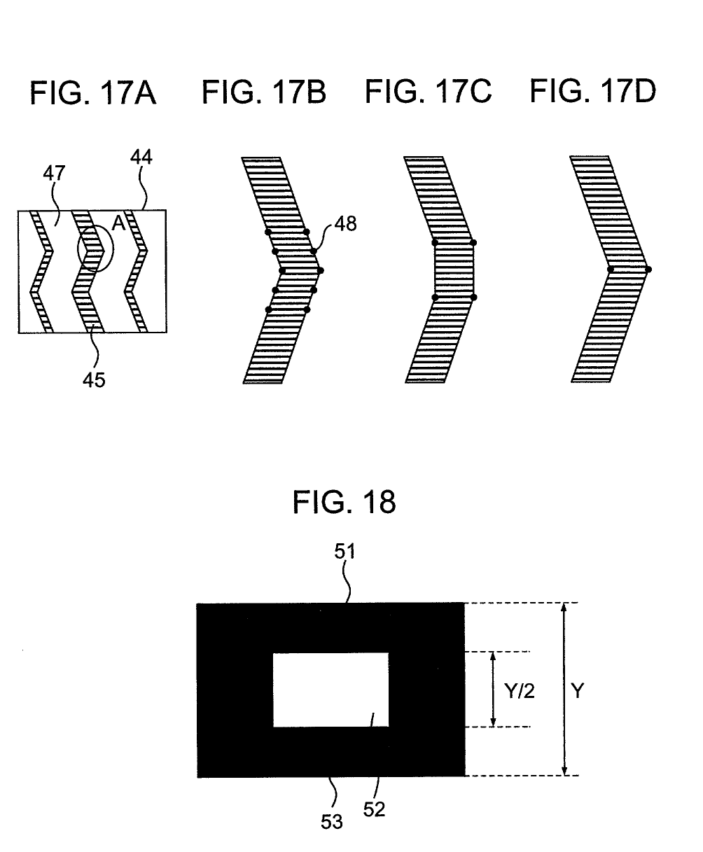

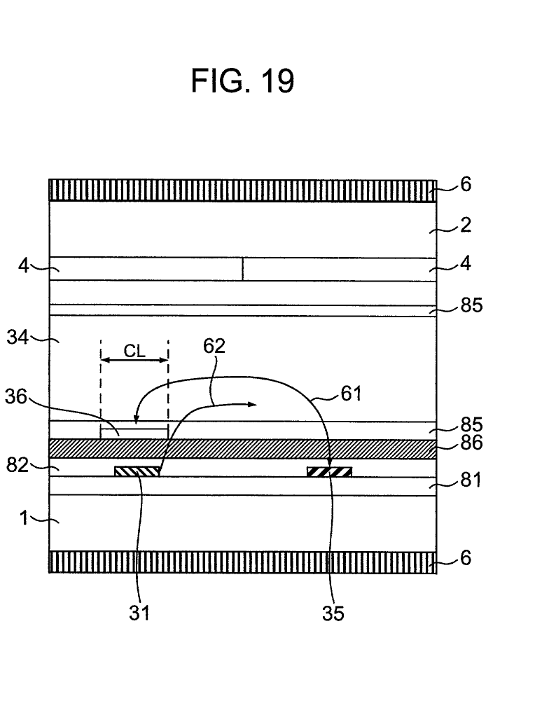

At this step for this embodiment of the invention, a photomask shown in FIGS. 17A through 17D in particular was used to intentionally make the bent portions of signal lines curvilinear. FIG. 17A shows only that part of the photomask shape in the vicinity of a signal line, and expanded views of area A are shown in FIGS. 17B through 17D.

In a usual photomask, as shown in FIG. 17D, the bent portion is formed having one vertex. However, the bent portion has three vertexes in this embodiment as shown in FIG. 17B. Yet, to shape the signal line to have a curved part, preferably there should be a plurality of (three or more) such vortexes. It is also conceivable that part of the bent portion be shaped as shown in FIG. 17C to have an area parallel to the extending direction of the signal lines.

Following this development/post-baking step (FIG. 16D), the part not covered by the resist is etched off (FIG. 16D), and the final stage of resist removal gives the desired electrodes and wiring pattern (FIG. 16F).

FIG. 1B shows an expanded view of the bent portion (B) of the signal line 31 in FIG. 1A. The bent portion of the signal line 31 is rounded into a curved shape. As a result, electric field concentration in the bent portion is eased, and the line width CL of the common electrode 36 can be made narrower than that in the conventional electrode structure.

FIG. 8 shows an A-A′ section of FIG. 1A. This configuration has a substrate 1 made of transparent glass, another substrate 2 arranged opposite the substrate 1 and also made of transparent glass, and a liquid crystal layer 34 held between the substrates 1 and 2.

The substrate 1 has an insulating film 81, a signal line 31 and pixel electrodes 35 both arranged over the insulating film 81, a protective film 82 arranged over these electrodes 35, a low-dielectric constant insulating film 86 arranged over the protective film 82, a common electrode 36 superposed over the signal line 31 via the low-dielectric constant insulating film 86, an alignment film 85 arranged on the boundary with the liquid crystal 34, and a polarizer 6 arranged on the other side than the liquid crystal side of the substrate 1 and varying its optical characteristic according to the alignment of the liquid crystal.

The common electrode 36, the pixel electrode 35 and the signal line 31 are made of conductors of about 0.2 μm in thickness, which may be CrMo, Al, indium tin oxide (ITO) or the like.

The insulating film 81 and the protective film 82 are made of insulators of respectively about 0.3 μm and 0.8 μm in thickness, which may be silicon nitride or the like. The low-dielectric constant insulating film 86 is made of an insulator of about 1 μm in thickness, which may be either an inorganic or organic substance. In order to reduce the capacitance generating between the signal line 31 and the common electrode 36, it is desirable to use an insulator having a low dielectric constant. To add, the film thicknesses stated above are by no means absolute requirements.

The substrate 2 has a color filter 4 for expression colors respectively corresponding to R, G and B, a flattening film 3 for flattening the unevenness of the filter, the alignment film 85 over the flattening film 3, and the polarizer 6 over the other side than the liquid crystal side of the substrate 2.

The alignment film 85 is rubbed to align the liquid crystal. The rubbing direction is parallel to the extending direction of the signal line. The angle formed between one side of the bent pixel electrode and the rubbing direction is 15 degrees, matching the IPS display mode.

The axis of transmission of the polarizer 6 is in the rubbing direction of the alignment film on the substrate over which that particular polarizer is arranged, and the polarizer of the substrate 1 and the polarizer of the substrate 2 are in a cross Nicol arrangement, matching the normally black mode. Incidentally, the present invention is not limited to the above-stated rubbing angle, and further is applicable to the normally white mode as well.

Between the substrate 1 and the substrate 2, there are dispersed high molecular beads for keeping the gaps of the liquid crystal layer uniform. The gaps are above 4 μm and the refractive index anisotropy of the liquid crystal layer is about 0.1, with this combination the retardation (Δnd) being adjusted. Incidentally, this retardation is not the only applicable one.

There is no limitation regarding the back light (not shown) either. For instance, a straight down type or a side light type can be used.

To add, the liquid crystal display apparatus embodying the invention in this manner uses active matrix driving.

In this embodiment, as shown in FIG. 1B, the noise field is reduced because the bent portion of the signal line 31 is curved, and the line width CL of the common electrode 36 can be minimized. As a result, where the pixel pitch is set to 216 μm, the width of the pixel electrode 35 to 5 μm, the width of the common electrode 36 not superposed over the signal line to 5 μm, the width of the signal line 31 to 6 μm, and the thickness of the low-dielectric constant insulating film 86 to 1 μm in the configuration shown in FIG. 1A, the width of the common electrode 36 superposed over the signal line can be restrained to 17 μm, and the longitudinal smear intensity to less than 3%.

Incidentally, supposing that the electrode is opaque and the total of the width of black matrix for shielding against light leaks from the vicinity of the scanning line 32 and the width of the common wiring 36″ arranged in parallel to the scanning line is 40 μm in this case, the aperture ratio will be about 45.3%.

### COMPARATIVE EXAMPLE 1

This comparative example differs from Embodiment 1 only in the shape of the bent portion of the signal line. The photomask used in forming the signal line is different from that for Embodiment 1, but one shaped as illustrated in FIG. 17D is used. Therefore, only this bent portion will be described here.

FIG. 7A illustrates the configuration of the pixel and its vicinity in Comparative Example 1; and FIG. 7B, an expanded view of the bent portion (B) of the signal line 31 in FIG. 1A. In this comparative example, the bent portion of the signal line 31 is pointed. As a result, electric field concentration occurs in the bent portion (D) with an increase in noise field.

It has been found that, in order to shield this noise field and restrain the longitudinal smear intensity to less than 3%, the width CL of the common electrode 36 superposed over the signal line should be about 21 μm. This resulted in a aperture ratio of about 40.7%, less than the aperture ratio of Embodiment 1.

[Embodiment 2]

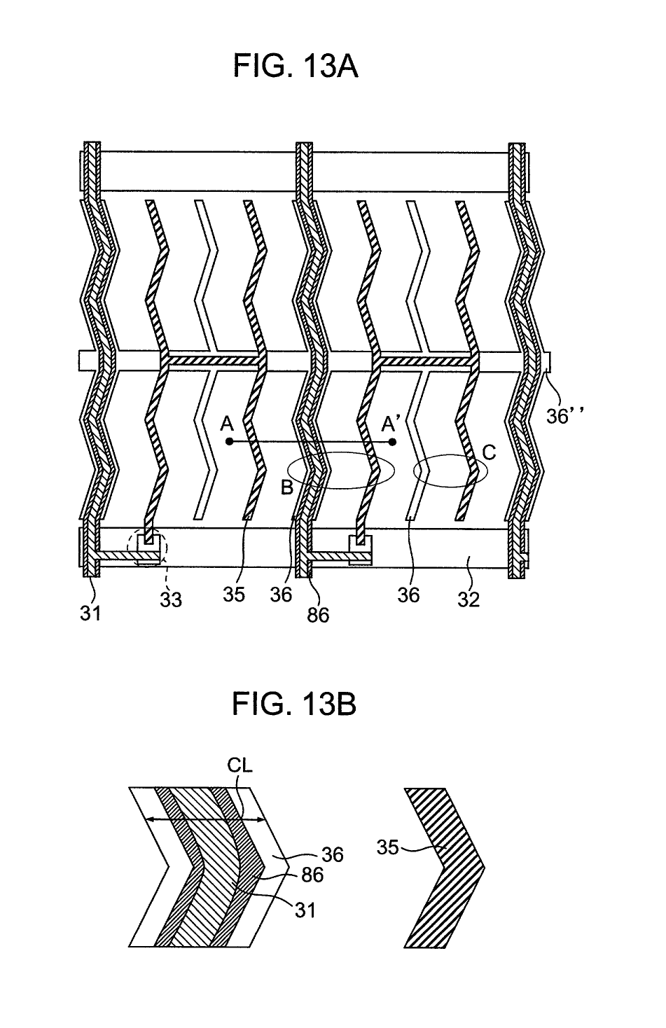

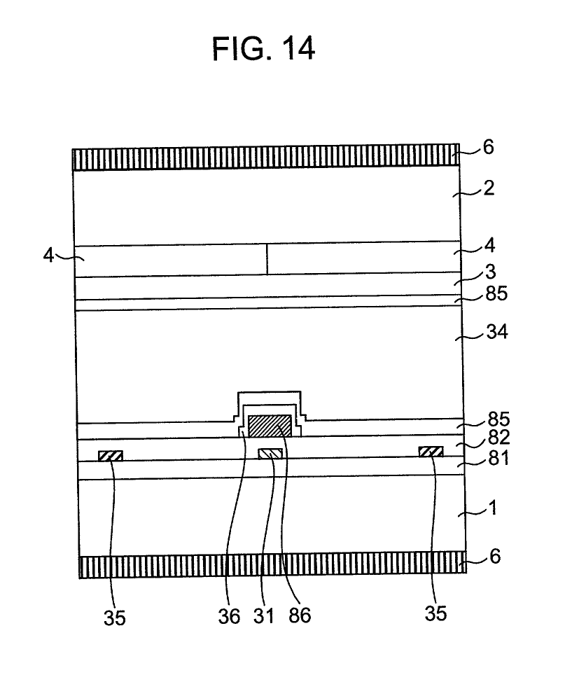

This embodiment differs from Embodiment 1 only in the shape of the low-capacitance insulating film. Therefore, it will be described with reference to FIGS. 13A, 13B and 14.

FIG. 13A illustrates the configuration of the pixel and its vicinity in this embodiment. The scanning line 32 and the signal line 31 cross each other, and the pixel is formed matching the area surrounded by scanning lines 32 and signal lines 31.

Each of the TFTs 33 is arranged in a matching way near the intersection between a scanning line 32 and a signal line 31, and electrically connected to the scanning line 32, the signal line 31 and the pixel electrode 35. Each of the common electrodes 36 is arranged matching a pixel electrode 35, and the common electrode 36 and the pixel electrode 35 generate an electric field whose components are parallel to the substrate surface.

The pixel electrode 35, the common electrode 36 and the signal line 31 are bent once or more within each pixel to constitute a multi-domain. The signal line 31 and the common electrode 36 are partly superposed via a low-dielectric constant insulating film 86 arranged over the signal line 31. While the low-dielectric constant insulating film 86 is arranged all over the pixel in Embodiment 1, it is arranged only over the superposed portion of the signal line 31 and the common electrode 36 in this embodiment, and the low-dielectric constant insulating film 86 is selectively formed in a smaller width than the common electrode. Thus in this configuration the low-dielectric constant insulating film 86 is not stacked in the pixel area.

FIG. 14 shows an A-A′ section of FIG. 13A. This configuration has a substrate 1 made of transparent glass, another substrate 2 arranged opposite the substrate 1 and also made of transparent glass, and a liquid crystal layer 34 held between the substrates 1 and 2.

The substrate 1 has an insulating film 81, a signal line 31 and pixel electrodes 35 both arranged over the insulating film, a protective film 82 arranged over the electrodes 35, a low-dielectric constant insulating film 86 arranged over the protective film 82 and on the superposed portion over the signal line 31, a common electrode 36 superposed over the signal line 31 via the low-dielectric constant insulating film 86, an alignment film 85 arranged on the boundary with the liquid crystal 34, and a polarizer 6 arranged on the other side than the liquid crystal side of the substrate 1 and varying its optical characteristic according to the alignment of the liquid crystal.

The common electrode 36, the pixel electrode 35 and the signal line 31 are made of conductors of about 0.2 μm in thickness, which may be CrMo, Al, ITO or the like.

The insulating film 81 and the protective film 82 are made of insulators of respectively about 0.3 μm and 0.8 μm in thickness, which may be silicon nitride or the like. The low-dielectric constant insulating film 86 is made of an insulator of about 1 μm in thickness, which may be either an inorganic or organic substance. In order to reduce the capacitance generating between the signal line 31 and the common electrode 36, it is desirable to use an insulator having a low dielectric constant. To add, the film thicknesses stated above are by no means absolute requirements.

FIG. 13B is an expanded view of the bent portion (B) of the signal line 31 in FIG. 13A. The bent portion of the signal line 31 is rounded into a curved shape. As a result, electric field concentration in the bent portion is eased, and the line width CL of the common electrode 36 can be minimized.

In this embodiment in particular, the common electrode 36 is formed to cover the low-dielectric constant insulating film 86, and there is no low-dielectric constant insulating film 86 on the straight line linking an edge of the signal line 31 and the corresponding edge of the common electrode 36. The distance between the edge of the signal line 31 and the corresponding edge of the common electrode 36 is shorter than that in Embodiment 1. As a result, the effect of the curved shape of the bent portion is greater here.

While the width of the signal line 31 is 6 μm, the line width CL of the common electrodes 36 is about 15 μm, providing a sufficient effect to shield the noise field and to keep the longitudinal smear intensity below 3% and resulting in a aperture ratio of about 47.5%.

### COMPARATIVE EXAMPLE 2

This comparative example differs from Embodiment 2 only in the shape of the bent portion of the signal line. The photomask used in forming the signal line is different from that for Embodiment 1, but one shaped as illustrated in FIG. 17D is used to intentionally round the bent portion. Therefore, only this bent portion will be described here.

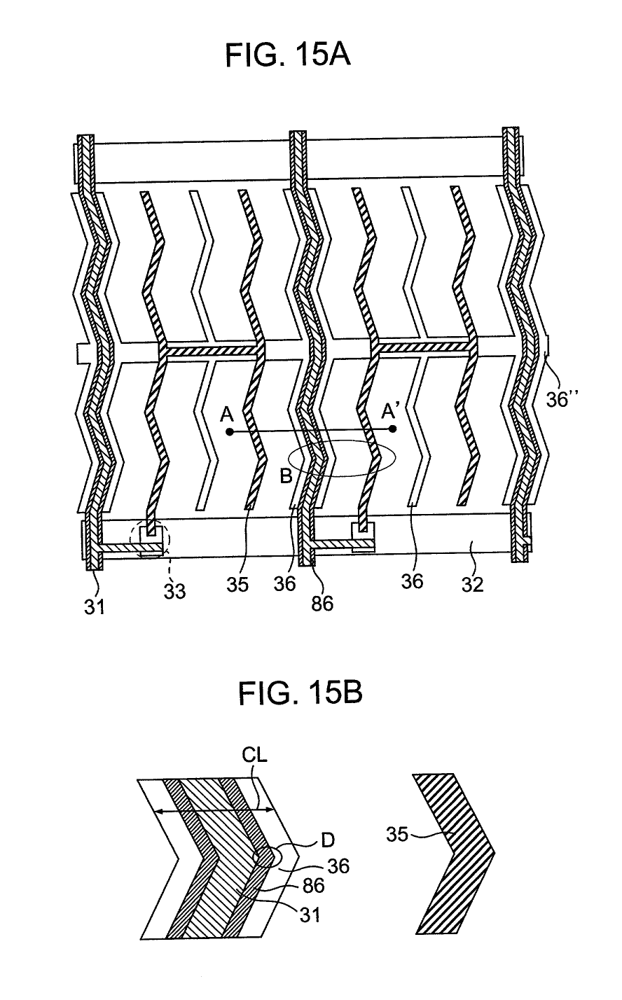

FIG. 15A illustrates the configuration of the pixel and its vicinity in this comparative example; and FIG. 15B, an expanded view of the bent portion (B) of the signal line 31 in FIG. 15A.

Since the bent portion of the signal line 31 is pointed as shown in FIG. 15B, electric field concentration occurs in the bent portion (D) with an increase in noise field. It has been found that, in order to shield this noise field and restrain the longitudinal smear intensity to less than 3%, the width Cl of the common electrode 36 should be about 20 μm. This resulted in a aperture ratio of about 41.9%, less than the aperture ratio of Embodiment 2.

[Embodiment 3]

This embodiment differs from Embodiment 2 only in the shape of the bent portion of the pixel electrode 35 and the common electrode 36. Therefore, this point will be described here with reference to FIGS. 11A, 11B, 13A and 13B.

FIG. 11B is an expanded view of the bent portion (C) of the pixel electrode 35 and the common electrode 36 in FIG. 13. The bent portion of the pixel electrode 35 and the common electrode 36 is rounded into a curved shape. As a result, electric field concentration in the bent portion is less intense than in the case where the bent portion of the pixel electrode 35 and the common electrode 36 is pointed as shown in FIG. 11A.

A high degree of electric field concentration causes electrically charged substances, such as ions, in the liquid crystal layer to be localized in the bent portion subjected to electric field concentration. In this case, the electric field for displaying is disturbed and prevented from providing proper displaying.

This embodiment can ease electric field concentration and therefore electric charge localization in the bent portion, resulting in high-quality displaying.

To add, while this embodiment is intended to improve the shape of the bent portion of the pixel electrode and the common electrode, it can be used in combination with Embodiment 1 or 2 which focuses on the bent portion of the signal line.

It should be further understood by those skilled in the art that the foregoing description has been made on embodiments of the invention and that various changes and modifications may be made in the invention without departing from the spirit of the invention and the scope of the appended claims.

What is claimed is:

1. A liquid crystal display apparatus comprising:
a first substrate;
a second substrate arranged opposite said first substrate;
a liquid crystal layer held between said first substrate and said second substrate;
a plurality of scanning lines arranged over said first substrate;
a plurality of zigzag-shaped signal lines having bent portions, arranged crossing said scanning lines over said substrate;
insulating films arranged over at least part of said plurality of signal lines;
pixel electrodes matching said plurality of signal lines; and
common electrodes matching said pixel electrodes and superposed over at least part of said plurality of signal lines via said insulating films,
wherein the bent portions of said zigzag-shaped signal lines are curved.

2. The liquid crystal display apparatus, as set forth in claim 1,
wherein at least one layer of said insulating films is selectively formed in a smaller width than said common electrodes in the part where said signal lines and said common electrodes are superposed.

3. The liquid crystal display apparatus, as set forth in claim 1,
wherein said pixel electrodes and said common electrodes are formed in dogleg shapes having bent portions; and
at least part of the bent portions of said pixel electrodes and part of the bent portions of said common electrodes are curved.

4. The liquid crystal display apparatus, as set forth in claim 1,
wherein said pixel electrodes and said common electrodes are formed in dogleg shapes having bent portions; and
at least part of the bent portions of said pixel electrodes and part of the bent portions of said common electrodes are bent stepwise at a plurality of angles.

5. The liquid crystal display apparatus, as set forth in claim 1,
wherein said pixel electrodes and said common electrodes are formed in dogleg shapes having bent portions; and
at least part of the bent portions of said pixel electrodes and part of the bent portions of said common electrodes have parts parallel to the extending direction of said pixel electrodes.

6. A liquid crystal display apparatus comprising:
a first substrate;
a second substrate arranged opposite said first substrate;
a liquid crystal layer held between said first substrate and said second substrate;
a plurality of scanning lines arranged over said first substrate;
a plurality of zigzag-shaped signal lines having bent portions, arranged crossing said scanning lines over said substrate;
insulating films arranged over at least part of said plurality of signal lines;
pixel electrodes matching said plurality of signal lines; and
common electrodes matching said pixel electrodes and superposed over at least part of said signal lines via said insulating films,
wherein the bent portions of said zigzag-shaped signal lines are bent stepwise at a plurality of angles.

7. A liquid crystal display apparatus comprising:
a first substrate;
a second substrate arranged opposite said first substrate;
a liquid crystal layer held between said first substrate and said second substrate;
a plurality of scanning lines arranged over said first substrate;
a plurality of zigzag-shaped signal lines having bent portions, arranged crossing said scanning lines over said substrate;
insulating films arranged over at least part of said plurality of signal lines;
pixel electrodes matching said plurality of signal lines; and
common electrodes matching said pixel electrodes and superposed over at least part of said signal lines via said insulating films,
wherein the bent portions of said zigzag-shaped signal lines have parts parallel to the extending direction of the signal lines.

8. A liquid crystal display apparatus comprising:
a first substrate;
a second substrate arranged opposite said first substrate;
a liquid crystal layer held between said first substrate and said second substrate;
a plurality of scanning lines arranged over said first substrate;
signal lines arranged crossing said scanning lines over said substrate; dogleg-shaped pixel electrodes matching said signal lines and having bent portions; and
dogleg-shaped common electrodes matching said pixel electrodes and having bent portions,
wherein at least part of the bent portion of the pixel electrodes and part of the bent portion of the common electrodes are curved.

9. A liquid crystal display apparatus comprising:
a first substrate;
a second substrate arranged opposite said first substrate;
a liquid crystal layer held between said first substrate and said second substrate;
a plurality of scanning lines arranged over said first substrate;
signal lines arranged crossing said scanning lines over said substrate; dogleg-shaped pixel electrodes matching said signal lines and having bent portions; and
dogleg-shaped common electrodes matching said pixel electrodes and having bent portions,
wherein at least part of the bent portion of said pixel electrodes and part of the bent portion of said common electrodes are bent stepwise at a plurality of angles.

10. A liquid crystal display apparatus comprising:
a first substrate;
a second substrate arranged opposite said first substrate;
a liquid crystal layer held between said first substrate and said second substrate;
a plurality of scanning lines arranged over said first substrate;
signal lines arranged crossing said scanning lines over said substrate; dogleg-shaped pixel electrodes matching said signal lines and having bent portions; and
dogleg-shaped common electrodes matching said pixel electrodes and having bent portions,
wherein at least part of the bent portion of said pixel electrodes and part of the bent portion of said common electrodes have parts parallel to the extending direction of said pixel electrodes.
